(19) United States
(12) Patent Application Publication
(10) Pub. No.: US 2019/0053263 A1
(43) Pub. Date: Feb. 14, 2019

(54) SUBFRAME CONFIGURATION METHOD, DATA TRANSMISSION METHOD, RELATED DEVICE AND SYSTEM

(71) Applicant: YULONG COMPUTER TELECOMMUNICATION SCIENTIFIC (SHENZHEN) CO., LTD., Shenzhen, Guangdong (CN)

(72) Inventors: Ya-Jun ZHU, Shenzhen (CN); Ming-Ju LI, Shenzhen (CN); Yun-Fei ZHANG, Shenzhen (CN)

(73) Assignee: Yulong Computer Telecommunication Scientific (Shenzhen) Co., Ltd., Shenzhen, Guangdong (CN)

(21) Appl. No.: 16/075,667

(22) PCT Filed: Sep. 28, 2016
(86) PCT No.: PCT/CN2016/100655

§ 371 Date: Aug. 6, 2018

(30) Foreign Application Priority Data
Feb. 5, 2016 (CN) 201610081930.3

(51) Int. Cl. H04W 72/12; H04W 72/04

(52) U.S. Cl. CPC H04W 72/1278; H04W 72/04; H04W 72/1284; H04W 72/0446; H04W 72/12

(57) ABSTRACT

The present disclosure provides a subframe configuration method, includes that a base station generates configuration information; the base station sends the configuration information to a terminal, and the configuration information is used for indicating the terminal to demodulate a scheduling instruction for supporting a multi-subframe or cross-subframe scheduling on a subframe corresponding to subframe position information, and to perform a multi-subframe or cross-subframe data transmission according to an indication of the scheduling instruction. The present disclosure further provides a data transmission method, a base station and a terminal. By utilizing the present disclosure, the terminal accurately locates and extracts the scheduling instruction to realize the multi-subframe or cross-subframe scheduling.

### CROSS-REFERENCE TO RELATED APPLICATIONS

This application claims priority of Chinese Patent Application No. 201610081930.3, entitled “SUBFRAME CONFIGURATION METHOD, DATA TRANSMISSION METHOD, RELATED DEVICE AND SYSTEM,” filed on Feb. 5, 2016 in the SIPO (State Intellectual Property Office of the People's Republic of China), the entire contents of which are incorporated by reference herein.

### FIELD

The embodiments of the present disclosure relates to a technical field of communication, specifically a subframe configuration method, a data transmission method, a related device and a system.

### BACKGROUND

With the rapid development of mobile services, a capacity of existing wireless frequency spectrums allocated to the mobile service cannot meet requirements. In the 3GPP Rel-13 phase, a mechanism called Licensed-Assisted Access (LAA) is introduced. In the LAA mechanism, a transmission of mobile communication can be performed on unlicensed frequency spectrums, such as 5 GHz frequency bands. Currently, the unlicensed frequency spectrums are mainly used by Wi-Fi™, BLUETOOTH™, radar, medical systems, etc.

Due to diversity and complexity of system on an unlicensed frequency spectrum, the direct use of a Long Term Evolution (LTE) mechanism on the unlicensed frequency spectrum cannot guarantee security of users and stability of connection. Therefore, in the mechanism of the LAA, through a Collision Avoidance (CA) mechanism, the licensed frequency spectrum is used to help access on the unlicensed frequency spectrum. At present, when the LTE is used on the unlicensed frequency spectrum, the system can have two working modes, as shown in a following figure:

In an LAA system, in order to ensure fair sharing of unlicensed frequency spectrums with other systems, a mechanism of Listening Before Talk (LBT) is introduced. That is to say, before sending data, a sending end is required to detect whether a channel is idle, the data can be sent only when the channel is idle. Due to usage of a LBT mechanism, a data transmission to a base station or a terminal can be discontinuous.

In a design of the LAA, considering a limitation of maximum transmission time after occupying a channel, it is necessary to reduce transmission cost of control signaling as little as possible. In addition, for a transmission of uplink data, limited by the maximum transmission time limit and traditional scheduling restrictions, a problem that scheduling instructions cannot be found may be caused. Therefore, a concept of multi-subframe scheduling or cross-subframe scheduling is proposed at present, however, how to perform a cross-subframe or multi-subframe scheduling is a hot point for a target research.

### SUMMARY

A technical problem to be solved in an embodiment of the present disclosure is to provide a subframe configuration method, a data transmission method, a related device and a system. A terminal is enabled to accurately locate and extract scheduling instructions for multi-subframe or cross-subframe scheduling.

In order to solve the technical problem, an embodiment of the present disclosure provides a subframe configuration method, which includes that:

A base station generates configuration information;

The base station sends the configuration information to a terminal, and the configuration information is used for indicating the terminal to demodulate a scheduling instruction for supporting a multi-subframe or cross-subframe scheduling on a subframe corresponding to subframe position information, and to perform a multi-subframe or cross-subframe data transmission according to an indication of the scheduling instruction.

Correspondingly, an embodiment of the present disclosure further provides a data transmission method, which includes that:

The terminal receives the configuration information sent by the base station, and the configuration information includes the subframe position information of the scheduling instruction;

The terminal demodulates the scheduling instruction for supporting the multi-subframe or cross-subframe scheduling on the subframe corresponding to the subframe position information;

The terminal performs an operation of a multi-subframe or cross-subframe data transmission according to the indication of the scheduling instruction.

Correspondingly, an embodiment of the present disclosure further provides a base station, which includes:

A generation module configured to generate configuration information, and the configuration information includes subframe position information of a scheduling instruction;

A first sending module configured to send the configuration information to a terminal, and the configuration information is used for indicating the terminal to demodulate a scheduling instruction for supporting a multi-subframe or cross-subframe scheduling on a subframe corresponding to subframe position information, and to perform a multi-subframe or cross-subframe data transmission according to an indication of the scheduling instruction.

Correspondingly, an embodiment of the present disclosure further provides a terminal, which includes that:

A receiving module configured to receive the configuration information sent by the base station, and the configuration information includes the subframe position information of the scheduling instruction for supporting multi-subframe or cross-subframe scheduling;

A demodulation module configured to demodulate the scheduling instruction for supporting the multi-subframe or cross-subframe scheduling on the subframe corresponding to the subframe position information;

A transmission module configured to perform an operation of a multi-subframe or cross-subframe data transmission according to the indication of the scheduling instruction.

The embodiments of the present disclosure has the following beneficial effects:

The base station sends the configuration information including scheduling subframe position information to the terminal, the configuration information is used for indicating the terminal to demodulate the scheduling instruction on the subframe corresponding to the subframe position information, and to perform the multi-subframe or cross-subframe data transmission according to the indication of the scheduling instruction, thus the terminal can accurately locate and extract the scheduling instruction to realize scheduling of multi-subframe or cross-subframe.

### BRIEF DESCRIPTION OF THE DRAWINGS

In order to describe the technical solutions in embodiments of the present disclosure or in the prior art more clearly, the following briefly introduces the accompanying drawings needed for describing the embodiments or the prior art. The accompanying drawings in the following description show some embodiments of the present disclosure, and persons of ordinary skill in the art may still derive other drawings from these accompanying drawings without creative efforts.

FIG. 1 is a schematic flow diagram of a subframe configuration method provided in an embodiment of the present disclosure;

FIG. 2 is a schematic flow diagram of a data transmission method provided in an embodiment of the present disclosure;

FIG. 3 is a schematic structural diagram of a base station provided in an embodiment of the present disclosure;

FIG. 4 is another schematic structural diagram of a base station provided in an embodiment of the present disclosure;

FIG. 5 is a schematic structural diagram of a terminal provided in an embodiment of the present disclosure;

FIG. 6 is another schematic structural diagram of a terminal provided in an embodiment of the present disclosure.

### DETAILED DESCRIPTION

The following clearly and completely describes the technical solutions in the embodiments of the present disclosure with reference to the accompanying drawings in the embodiments of the present disclosure. The described embodiments are only a part rather than all of the embodiments of the present disclosure. All other embodiments acquired by persons of ordinary skill in the art based on the embodiments of the present disclosure without creative efforts shall fall within the protection scope of the present disclosure.

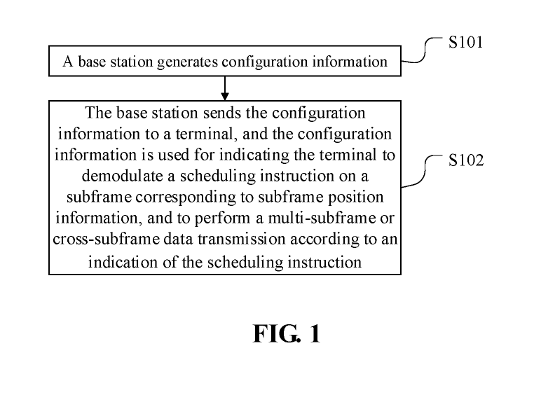

Referring to FIG. 1, a schematic flow diagram of a subframe configuration method provided in an embodiment of the present disclosure is shown, in the embodiment of the present disclosure, the method includes that:

S101, a base station generates configuration information, and the configuration information includes subframe position information of a scheduling instruction for supporting a multi-subframe or cross-subframe scheduling.

Specifically, the subframe position information is used for representing the subframe position where the scheduling instruction for supporting the multi-subframe or cross-subframe scheduling is located, the subframe position information can be represented by a subframe number.

S102, the base station sends the configuration information to a terminal, and the configuration information is used for indicating the terminal to demodulate the scheduling instruction for supporting the multi-subframe or cross-subframe scheduling on the subframe corresponding to the subframe position information, and to perform the multi-subframe or cross-subframe data transmission according to the indication of the scheduling instruction.

Specifically, the configuration information can be notified to the terminal through Radio Resource Control (RRC) signaling, Media Access Control (MAC) Control Element (CE) signaling, or physical signaling in the unlicensed frequency band or the licensed frequency band. The terminal receives the configuration information, analyzes and obtains the subframe position information included in the configuration information, and demodulates the scheduling instruction for supporting the multi-subframe or cross-subframe scheduling on the subframe corresponding to subframe position information, and the scheduling instruction is divided into an uplink scheduling instruction and a downlink scheduling instruction, and the terminal performs a multi-subframe or cross-subframe data transmission according to the indication of the scheduling instruction. The multi-subframe data transmission means that one scheduling instruction schedules a plurality of subframes for a data transmission, for example, the scheduling instruction on the subframe n can schedule a subframe n, a subframe n+1 and a subframe n+2 for the data transmission; the cross-subframe data transmission means that the scheduling instruction on a current subframe is used to schedule other subframes for the data transmission, for example, the scheduling instruction on the subframe n can schedule a subframe n+3 for the data transmission.

Optionally, in order to reduce overhead of a signaling interaction, the terminal can detect whether a scheduling instruction for supporting a multi-subframe or cross-subframe scheduling is existed on each downlink subframe. When the scheduling instruction for supporting the multi-subframe or the cross-subframe scheduling is existed, the terminal performs the multi-subframe or cross-subframe data transmission according to the indication of the scheduling instruction.

Optionally, before the base station sends the configuration information to the terminal, the method further includes that:

The base station sends high layer signaling or physical signaling carrying trigger signaling or a trigger indicator to the terminal, the trigger signaling and the trigger indicator are used for indicating the terminal to detect the scheduling instruction for supporting the multi-subframe or cross-subframe scheduling.

Optionally, the method further includes that:

The base station sends high layer signaling or physical signaling carrying release signaling or a release indicator to the terminal, the release signaling and the release indicator are used for indicating the terminal to stop detecting the scheduling instruction for supporting the multi-subframe or cross-subframe scheduling.

Specifically, the base station controls the terminal to start or stop detecting the scheduling instruction for supporting the multi-subframe or cross-subframe scheduling on the downlink subframe, for example, when the terminal receives the indication of the base station, and starts detecting the scheduling instruction for supporting the multi-subframe or cross-subframe scheduling, the terminal can detect the scheduling instruction for supporting the multi-subframe or cross-subframe scheduling on the subframe notified by the base station or on all the downlink subframes, the terminal performs the multi-subframe or cross-subframe data transmission according to the detected indication of the scheduling instruction. When the base station indicates the terminal to stop detecting the scheduling instruction used for the multi-subframe or cross-subframe data transmission, the terminal stops detecting the scheduling instruction used for the multi-subframe data transmission and the cross-subframe data transmission, that is, the operation of data transmission between multi-subframe or cross-subframe is no longer performed, and only the scheduling instruction of a non-multi-subframe scheduling or a non-cross-subframe scheduling is detected. A mode that the base station indicates the terminal to start detecting the multi-subframe or cross-subframe data transmission can be that the base station sends high layer signaling or physical signaling carrying the trigger signaling or the release signaling, the high layer signaling or physical signaling can be signaling used for transmitting public information or for user exclusive information, the triggering signaling is used for instructing the terminal to start detecting the scheduling instruction used for the multi-subframe or cross-subframe data transmission, the release signaling is used for instructing the terminal to stop detecting the scheduling instruction used for the multi-subframe or cross-subframe data transmission.

Optionally, the base station sends the configuration information to the terminal, includes that:

The base station sends the configuration information to the terminal through signaling in the licensed frequency band or the unlicensed frequency band, the signaling includes any one of RRC signaling, MAC CE signaling and physical signaling.

Optionally, the configuration information includes: position information of a scheduled subframe, number information of the scheduled subframe, scheduling type information and transmission format information.

Specifically, the scheduled subframe represents a subframe used for the multi-subframe or cross-subframe data transmission, and the position information of the scheduled sub-frame is used for representing a position of one or more sub-frames used for the multi-subframe or cross-subframe data transmission, and the specific position of the scheduled sub-frame is determined according to the position of the scheduled signaling and the subframe location information in the configuration information.

The number information of the scheduled subframe indicates the number of the scheduled subframe used for the multi-subframe or cross-subframe data transmission. The scheduling type information represents a scheduling direction that is divided into uplink scheduling and downlink scheduling, the transmission format information represents the transmission format of the data on the scheduled sub-frame, and the transmission format includes a level of the Modulation and Coding Scheme (MCS), on the multi-subframe scheduling or cross-subframe scheduling, the data transmission format on each scheduled subframe can be same or different. When the data transmission format on each scheduled subframe is different, the base station can specify the transmission format of each sub-frame in the configuration information, to better match channel conditions.

Optionally, in a case that scheduling type information represents an uplink transmission, the configuration information further includes: initial position information of the uplink transmission.

Specifically, when the scheduling type information represents the uplink transmission, the scheduling instruction further includes initial position information of the uplink transmission, for example, the terminal demodulates the scheduling instruction used for the multi-subframe or cross-subframe data transmission on the subframe n, and meanwhile, the terminal is notified that the scheduling type information is the uplink transmission according to the configuration information, the terminal acquires the initial position information as being the sub-frame n+4 from the configuration information, and the terminal starts performing the uplink transmission from the subframe n+4 according to the location information, data information and transmission format of the scheduled subframe in the configuration information.

It can be seen from the above embodiments that the base station sends the configuration information including the position information of the scheduling subframe to the terminal, and the configuration information is used for indicating the terminal to demodulate the scheduling instruction for supporting the multi-subframe or cross-subframe scheduling on the subframe corresponding to the subframe position information, and to perform the multi-subframe or cross-subframe data transmission according to the indication of the scheduling instruction, thus, the terminal can accurately locate and extract the scheduling instruction, to realize the multi-subframe or cross-subframe scheduling.

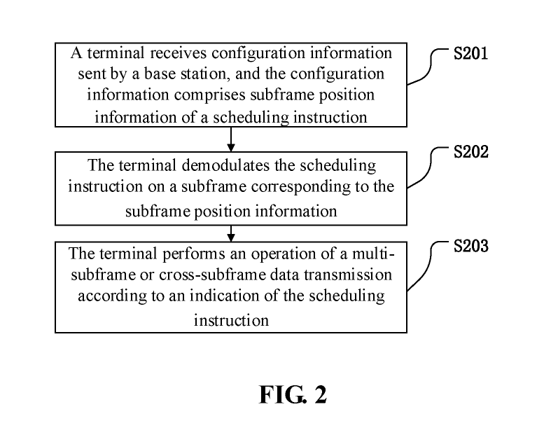

As shown in FIG. 2, FIG. 2 is a schematic flow diagram of a data transmission method provided in an embodiment of the present disclosure, in the embodiment of the present disclosure, the method includes that:

S201, a terminal receives configuration information sent by a base station, and the configuration information includes subframe position information of a scheduling instruction for supporting a multi-subframe or cross-subframe scheduling.

Specifically, the subframe position information is used for representing the subframe position where the scheduling instruction for supporting the multi-subframe or cross-subframe scheduling is located, the subframe position information can be represented by a subframe number; the configuration information can be sent by the base station on the unlicensed frequency spectrum or the licensed frequency spectrum through the RCC signaling, MAC CE or physical signaling.

S202, the terminal demodulates the scheduling instruction for supporting a multi-subframe or cross-subframe scheduling on a subframe corresponding to subframe position information.

S203, the terminal performs an operation of a multi-subframe or cross-subframe data transmission according to the indication of the scheduling instruction for supporting the multi-subframe or cross-subframe scheduling.

Specifically, the terminal receives the configuration information and parses the configuration information to obtain the subframe position information included in the configuration information, and the terminal demodulates the scheduling instruction for supporting the multi-subframe or cross-subframe scheduling on the subframe corresponding to subframe position information, the scheduling instruction is divided into an uplink scheduling instruction and a downlink scheduling instruction, and the terminal performs a multi-subframe or cross-subframe data transmission according to the indication of the scheduling instruction. The multi-subframe data transmission represents that one scheduling instruction schedules a plurality of subframes for the data transmission, the cross-subframe data transmission represents that the scheduling instruction on a current subframe is used to schedule other subframes for the data transmission.

In another optional embodiment, in order to reduce overhead of signaling interaction, the terminal detects whether a scheduling instruction for supporting a multi-subframe or cross-subframe scheduling is existed on each subframe. The terminal performs the operation of the multi-subframe or cross-subframe data transmission according to the detected indication of the scheduling instruction.

Optionally, before the terminal performs the operation of the multi-subframe or cross-subframe data transmission according to the indication of the scheduling instruction, the method further includes that:

When the terminal receives high layer signaling or physical signaling carrying trigger signaling or trigger indicator sent by the base station, the terminal performs the scheduling instruction for supporting the multi-subframe or cross-subframe scheduling instruction demodulated on a subframe corresponding to subframe position information.

Specifically, the trigger signaling is a self-defined signaling, the trigger indicator is a self-defined character string, and the high layer signaling can be an RRC signaling or a MAC CE signaling. After the base station indicates the terminal to start detecting the scheduling instruction used for multi-subframe or cross-subframe data transmission, the terminal can start detecting the scheduling instruction on the subframe notified by the base station or on all downlink subframes.

In some embodiments of the present disclosure, before the terminal detects whether the scheduling instruction used for multi-subframe or cross-subframe data transmission exists on each downlink subframe, the method further includes that:

When the terminal receives high layer signaling or physical signaling carrying trigger signaling or trigger indicator sent by the base station, the terminal performs detecting whether the scheduling instruction used for multi-subframe or cross-subframe data transmission exists on each downlink subframe.

Specifically, when the terminal receives trigger signaling or trigger indicator notified by the base station, the terminal starts detecting the scheduling instruction used for the multi-subframe or cross-subframe data transmission on each downlink subframe, the method further includes that:

When the terminal receives high layer signaling or physical signaling carrying release signaling or release indicator sent by the base station, the terminal stops detecting the scheduling instruction for supporting the multi-subframe or cross-subframe scheduling.

Specifically, when the base station indicates the terminal to stop detecting the scheduling instruction used for the multi-subframe or cross-subframe data transmission, the terminal stops detecting the scheduling instruction for supporting the multi-subframe or cross-subframe scheduling on the subframe notified by the base station or on all downlink subframes.

Specifically, the scheduled subframe represents a subframe used for the multi-subframe or cross-subframe data transmission, and the position information of the scheduled sub-frame is used for representing a position of one or more sub-frames used for the multi-subframe or cross-subframe data transmission, and the specific position of the scheduled sub-frame is determined according to the position of the scheduled signaling and the subframe location information in the configuration information.

The number information of the scheduled subframe indicates the number of the scheduled subframe used for the multi-subframe or cross-subframe data transmission. The scheduling type information represents a scheduling direction that is divided into uplink scheduling and downlink scheduling, the transmission format information represents the transmission format of the data on the scheduled sub-frame, and the transmission format includes a level of the Modulation and Coding Scheme (MCS), on the multi-subframe scheduling or cross-subframe scheduling, the data transmission format on each scheduled subframe can be same or different. When the data transmission format on each scheduled subframe is different, the base station can specify the transmission format of each sub-frame in the configuration information, to better match channel conditions.

Optionally, in a case that scheduling type information represents an uplink transmission, the configuration information further includes: initial position information of the uplink transmission.

Specifically, when the scheduling type information represents the uplink transmission, the scheduling instruction further includes initial position information of the uplink transmission, for example, the terminal demodulates the scheduling instruction used for the multi-subframe or cross-subframe data transmission on the subframe n, and meanwhile, the terminal is notified that the scheduling type information is the uplink transmission according to the configuration information, the terminal acquires the initial position information as the sub-frame n+4 from the configuration information, and the terminal starts performing the uplink transmission from the subframe n+4 according to the location information, data information and transmission format of the scheduled subframe in the configuration information.

It can be seen from the above embodiments that the terminal demodulates the scheduling instruction for supporting the multi-subframe or cross-subframe scheduling according to the subframe corresponding to the subframe position information notified by the base station, and performs the multi-subframe or cross-subframe data transmission according to the indication of the scheduling instruction, thus, the terminal can accurately locate and extract the scheduling instruction, to realize the multi-subframe or cross-subframe scheduling.

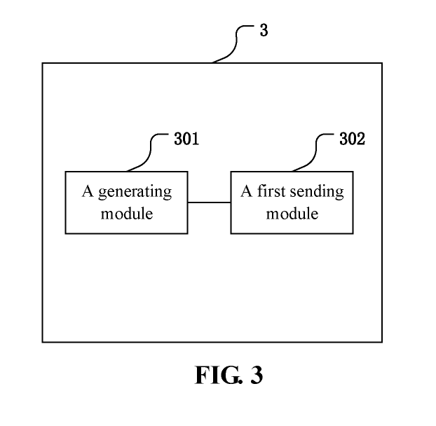

As shown in FIG. 3, FIG. 3 is a schematic structural diagram of a base station provided in an embodiment of the present disclosure, a base station is used for performing a subframe configuration method in FIG. 1, a term and a process involved in the present disclosure can be described with reference to a description of an embodiment of FIG. 1. A base station 3 includes: a generating module 301 and a first sending module 302.

The generating module 301 configured to generate configuration information, and the configuration information includes subframe position information of a scheduling instruction.

The first sending module 302 configured to send the configuration information to a terminal, and the configuration information is used for indicating the terminal to demodulate the scheduling instruction for supporting the multi-subframe or cross-subframe scheduling on the subframe corresponding to the subframe position information, and to perform the multi-subframe or cross-subframe data transmission according to the indication of the scheduling instruction.

Optionally, the base station 3 further includes:

A second sending module configured to send high layer signaling or physical signaling carrying release signaling or a release indicator to the terminal, the release signaling and the release indicator are used for indicating the terminal to stop detecting the scheduling instruction for supporting a multi-subframe or cross-subframe scheduling; or

A third sending module configured to send high layer signaling or physical signaling carrying release signaling or a release indicator to the terminal, the release signaling and the release indicator are used for indicating the terminal to stop detecting the scheduling instruction for supporting a multi-subframe or cross-subframe scheduling.

Optionally, the first sending module 302 configured to:

Send the configuration information to the terminal through signaling in a licensed frequency band or an unlicensed frequency band, the signaling comprises any one of Radio Resource Control (RRC) signaling, Media Access Control (MAC) Control Element (CE) signaling and physical signaling.

Optionally, the configuration information includes: position information of a scheduled subframe, number information of the scheduled subframe, scheduling type information and transmission format information.

Optionally, under the condition that the scheduling type information represents an uplink transmission, wherein the configuration information further includes: initial position information of the uplink transmission.

The embodiment of the present disclosure and the embodiment of a method in FIG. 1 are based on the same concept, the technical effects brought by the methods are also the same; the specific process can be described with reference to the description of the first embodiment, the description of the method is not described in detail herein.

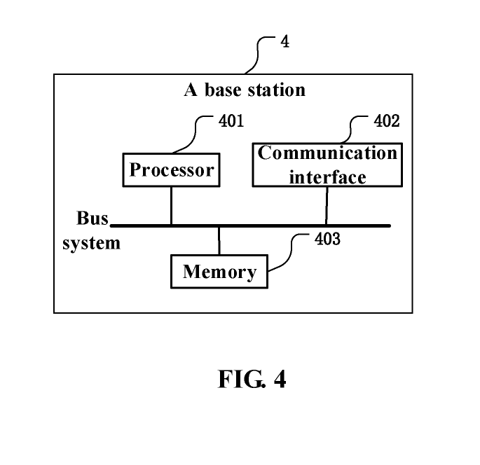

As shown in FIG. 4, FIG. 4 is another schematic structural diagram of a base station provided in an embodiment of the present disclosure. In the embodiment of the present disclosure, a base station 4 includes a processor 401, a memory 403, and a communication interface 402. The communication interface 402 is used for receiving and transmitting data between the communication interface 402 and the external equipment. The number of processors 401 in the base station 4 can be one or more. In some embodiments of the present disclosure, the processor 401, the memory 403, and the communication interface 402 can be connected through a bus system or other means. The base station 4 can be used for executing the method shown in FIG. 1. For the meaning and examples of the terms involved in the embodiment, and please refer to the corresponding embodiment in FIG. 1. The method is not further described herein.

The program code is stored in the memory 402. The processor 401 is used for calling program codes stored in the memory 403, and the processor 401 is used for executing the following operations:

Generating configuration information;

Sending the configuration information to a terminal, the configuration information being used for indicating the terminal to demodulate a scheduling instruction for supporting a multi-subframe or cross-subframe scheduling on a subframe corresponding to subframe position information, and to perform a multi-subframe or cross-subframe data transmission according to an indication of the scheduling instruction.

In some embodiments of the present disclosure, the processor 401 is further used for:

Sending the configuration information to the terminal through signaling in the licensed frequency band or the unlicensed frequency band, the signaling comprising any one of Radio Resource Control (RRC) signaling, Media Access Control (MAC) Control Element (CE) signaling and physical signaling.

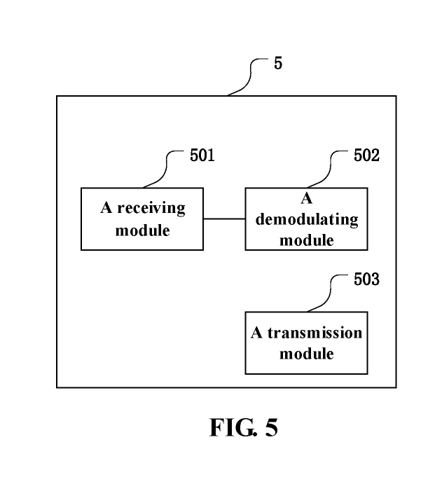

As shown in FIG. 5, FIG. 5 is a schematic structural diagram of a terminal provided in an embodiment of the present disclosure. The terminal in the embodiment of the present disclosure is used for executing a data transmission method shown in FIG. 2, a term and a process involved in the present disclosure can be described with reference to a description of an embodiment of FIG. 2. A terminal 5 includes: a receiving module 501, a demodulating module 502 and a transmission module 503.

The receiving module 501 configured to receive configuration information sent by a base station, the configuration information comprises subframe position information of a scheduling instruction.

The demodulating module 502 configured to demodulate the scheduling instruction for supporting a multi-subframe or cross-subframe scheduling on a subframe corresponding to the subframe position information.

The transmission module 503 configured to perform an operation of a multi-subframe or cross-subframe data transmission according to the indication of the scheduling instruction.

Optionally, the terminal 5 further includes:

A trigger module configured to indicate a demodulating module to start working when receiving high layer signaling or physical signaling carrying trigger signaling or a trigger indicator sent by a base station; or

A stopping module configured to stop detecting the scheduling instruction when receiving high layer signaling or physical signaling carrying release signaling or a release indicator sent by the base station.

Optionally, the configuration information includes: position information of a scheduled subframe, number information of the scheduled subframe, scheduling type information and transmission format information.

Optionally, under the condition that the scheduling type information represents an uplink transmission, wherein the configuration information further comprises: initial position information of the uplink transmission.

The embodiment of the present disclosure and the embodiment of a method in FIG. 2 are based on the same concept, the technical effects brought by the methods are also the same; the specific process can be described with reference to the description of the first embodiment, the description of the method is not described in detail herein.

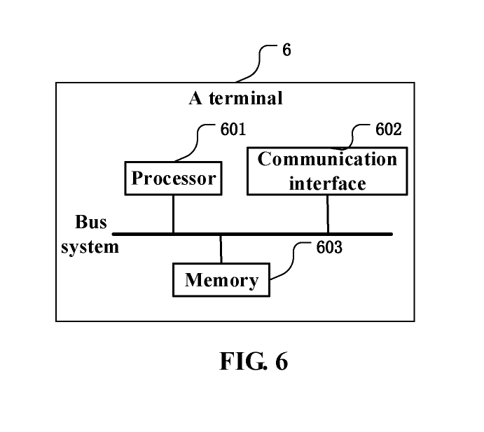

As shown in FIG. 6, FIG. 6 is another schematic structural diagram of a terminal provided in an embodiment of the present disclosure. In the embodiment of the present disclosure, the terminal 6 includes a processor 601, a memory 603, and a communication interface 602. The communication interface 602 is used for receiving and transmitting data between the communication interface 602 and the external equipment. The number of processors 601 in the terminal 6 can be one or more. In some embodiments of the present disclosure, the processor 601, the memory 603, and the communication interface 602 can be connected through a bus system or other means. The he terminal 6 can be used for executing the method shown in FIG. 2. For the meaning and examples of the terms involved in the embodiment, and please refer to the corresponding embodiment in FIG. 2. The method is not further described herein.

The program code is stored in the memory 602. The processor 601 is used for calling program codes stored in the memory 603, and the processor 601 is used for executing the following operations:

Receiving configuration information sent by a base station, the configuration information comprising subframe position information of a scheduling instruction;

Demodulating the scheduling instruction for supporting a multi-subframe or cross-subframe scheduling on a subframe corresponding to the subframe position information;

Performing an operation of a multi-subframe or cross-subframe data transmission according to an indication of the scheduling instruction.

In some embodiments of the present disclosure, before the processor 601 performing the operation of the multi-subframe or cross-subframe data transmission according to the indication of the scheduling instruction, the processor 601 further performing:

When receiving high layer signaling or physical signaling carrying trigger signaling or trigger indicator sent by the base station, the terminal performs the scheduling instruction for supporting the multi-subframe or cross-subframe scheduling instruction demodulated on a subframe corresponding to subframe position information.

In some embodiments of the present disclosure, the processor 601 further:

Stopping detecting the scheduling instruction when receiving high layer signaling or physical signaling carrying release signaling or a release indicator sent by the base station.

In some embodiments of the present disclosure, the configuration information includes: position information of a scheduled subframe, number information of the scheduled subframe, scheduling type information and transmission format information.

In some embodiments of the present disclosure, under the condition that the scheduling type information represents an uplink transmission, the configuration information further includes: initial position information of the uplink transmission.

The terminal provided by the embodiment of the present disclosure includes, but is not limited to, carrying IOS, an Android platform, a Microsoft corporation or other operating systems, such as mobile phones. It can also be other terminals, such as a laptop or tablet with a touch-sensitive surface (eg, a touch-screen display and/or a touch-control panel.), or a tablet computer or a desktop computer.

In the following discussion, a terminal including a display and a touch-sensitive surface is described. However, it should be appreciated that the terminal may include one or more other physical user interface devices, such as a physical keyboard, a mouse and/or an operating rod.

The terminal typically supports a variety of applications, such as one or more of the following: a drawing application programs, a presenting application programs, a text processing application program, a webpage creating application program, a disc editing application program, an electronic table application program, a game application program, a telephone application program, a video conference application program, an e-mail application program, an instant message application program, an exercise support application program, a photo management application program, a digital camera application program, a digital video camera application program, a network browsing application program, a digital music player application program and/or a digital video player application program.

Various applications executable on a terminal may use at least one shared physical user interface device, such as a touch sensitive surface. One or more functions of a touch-sensitive surface and corresponding information displayed on the terminal may be adjusted and/or changed from one application to a next application and/or to be adjusted and/or changed within a corresponding application. In this way, a common physical architecture (such as a touch-sensitive surface) of the terminal can support various application programs by using an user interface which is intuitive and clear to the user.

Persons of ordinary skill in the art can understand that all or part of the procedures in the method of the above embodiment can be realized, and can be completed by instructing relevant hardware through a computer program, the program can be stored in a computer readable storage medium, when the program is executed, the program can comprise the flow of the embodiments of the above methods. The storage medium can be a magnetic disk, an optical disk and a read-only memory (read-only memory) or random access memory (random access memory) or the like.

The method disclosed only one or several preferred embodiments of the present disclosure, thus the scope of the present disclosure cannot be limited, persons of ordinary skill in the art can understand the all or a part of the procedures of the above embodiment, the method and the device of the present disclosure are equivalent to those of the claims of the present disclosure, and all such methods and devices fall within the scope of the present disclosure.

1. A subframe configuration method, comprising:
a base station generating configuration information;
the base station sending the configuration information to a terminal, the configuration information being used for indicating the terminal to demodulate a scheduling instruction for supporting a multi-subframe or cross-subframe scheduling on a subframe corresponding to subframe position information, and to perform a multi-subframe or cross-subframe data transmission according to an indication of the scheduling instruction.

2. The method of claim 1, before the base station sending the configuration information to the terminal, further comprising:
the base station sending high layer signaling or physical signaling carrying trigger signaling or a trigger indicator to the terminal, the trigger signaling and the trigger indicator being used for indicating the terminal to detect the scheduling instruction.

3. The method of claim 2, further comprising:
the base station sending high layer signaling or physical signaling carrying release signaling or a release indicator to the terminal, the release signaling and the release indicator being used for indicating the terminal to stop detecting the scheduling instruction.

4. The method of claim 1, wherein the base station sending the configuration information to the terminal comprises:
the base station sending the configuration information to the terminal through signaling in the licensed frequency band or the unlicensed frequency band, the signaling comprising any one of Radio Resource Control (RRC) signaling, Media Access Control (MAC) Control Element (CE) signaling and physical signaling.

5. A data transmission method, comprising:
a terminal receiving configuration information sent by a base station, the configuration information comprising subframe position information of a scheduling instruction;
the terminal demodulating the scheduling instruction for supporting a multi-subframe or cross-subframe scheduling on a subframe corresponding to the subframe position information;
the terminal performing an operation of a multi-subframe or cross-subframe data transmission according to an indication of the scheduling instruction.

6. The method of claim 5, before the terminal performing the operation of the multi-subframe or cross-subframe data transmission according to the indication of the scheduling instruction, further comprising:
when the terminal receives high layer signaling or physical signaling carrying trigger signaling or a trigger indicator sent by the base station, the terminal performs a scheduling instruction for supporting a multi-subframe or cross-subframe scheduling instruction demodulated on a subframe corresponding to the subframe position information.

7. The method of claim 6, further comprising:
when the terminal receiving high layer signaling or physical signaling carrying release signaling or a release indicator sent by the base station, the terminal stops detecting the scheduling instruction.

8. The method of claim 1, wherein the configuration information comprises: position information of a scheduled subframe, number information of the scheduled subframe, scheduling type information and transmission format information.

9. The method of claim 8, under the condition that the scheduling type information represents an uplink transmission, wherein the configuration information further comprises: initial position information of the uplink transmission.

10.-12. (canceled)

13. A terminal, comprising:
at least one processor; and
a storage device storing a plurality of instructions, which when executed by the processor, causes the at least one processor to:
receive configuration information sent by a base station, the configuration information comprises subframe position information of a scheduling instruction;
demodulate the scheduling instruction for supporting a multi-subframe or cross-subframe scheduling on a subframe corresponding to the subframe position information;
perform an operation of a multi-subframe or cross-subframe data transmission according to the indication of the scheduling instruction.

14. The terminal of claim 13, further comprising:
indicates a demodulating module to start working when receiving high layer signaling or physical signaling carrying trigger signaling or a trigger indicator sent by a base station; or
stops detecting the scheduling instruction when receiving high layer signaling or physical signaling carrying release signaling or a release indicator sent by the base station.

15. The terminal of claim 13, wherein the configuration information comprises: position information of a scheduled subframe, number information of the scheduled subframe, scheduling type information and transmission format information.

16. The terminal of claim 15, under the condition that the scheduling type information representing uplink transmission, wherein the configuration information further comprises:
initial position information of the uplink transmission.

17. The terminal of claim 13, wherein the base station generates configuration information, sends the configuration information to the terminal, and the configuration information is used for indicating the terminal to demodulate the scheduling instruction for supporting the multi-subframe or cross-subframe scheduling on the subframe corresponding to subframe position information, and to perform the multi-subframe or cross-subframe data transmission according to the indication of the scheduling instruction.

18. The terminal of claim 18, wherein the base station further sends the high layer signaling or the physical signaling carrying the trigger signaling or the trigger indicator to the terminal, the release signaling and the release indicator are used for indicating the terminal to stop detecting the scheduling instruction; or
sends the high layer signaling or the physical signaling carrying the release signaling or the release indicator to the terminal, the release signaling and the release indicator are used for indicating the terminal to stop detecting the scheduling instruction.

19. The terminal of claim 18, wherein the base station sends the configuration information to the terminal through signaling in a licensed frequency band or an unlicensed frequency band, wherein the signaling comprises any one of Radio Resource Control (RRC) signaling, Media Access Control (MAC) Control Element (CE) signaling and physical signaling.
